(19) United States
(12) Patent Application Publication
(10) Pub. No.: US 2026/0024736 A1
(43) Pub. Date: Jan. 22, 2026

(54) RF Choke for Use in a Mass Spectrometer and RF Choke

(71) Applicant: DH Technologies Development Pte. Ltd., Singapore (SG)

(72) Inventors: Manuel FAUR, Toronto (CA); Andrei SONOC, Richmond Hill (CA)

(21) Appl. No.: 18/872,948

(22) PCT Filed: May 26, 2023
(86) PCT No.: PCT/IB2023/055448

§ 371 Date: Dec. 9, 2024

Related U.S. Application Data
(60) Provisional application No. 63/350,697, filed on Jun. 9, 2022.

(51) Int. Cl. H01J 49/02; H01F 1/03

(52) U.S. Cl. CPC H01J 49/022; H01F 1/0315

(57) ABSTRACT

A radio frequency (RF) choke for use in a mass spectrometer, comprising a bobbin having a hollow channel, a plurality of wire windings wrapped around said bobbin, each of said wire windings exhibiting a lattice winding pattern having about 1 to about 4 crossover per turn, and magnetic core disposed in said hollow channel of the bobbin.

### RELATED APPLICATIONS

This application claims priority to U.S. provisional application No. 63/350,697 filed on Jun. 9, 2022, entitled “RF Choke for use in a Mass Spectrometer and RF Choke,” which is incorporated herein by reference in its entirety.

### TECHNICAL FIELD

The present teachings are generally related to systems and methods for mass spectrometry, and more particularly to such systems and methods that can be employed in mass spectrometers, e.g., to reduce MRM mass analysis time.

### BACKGROUND

Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample. Mass spectrometers detect chemical entities as ions such that a conversion of the analytes to charged ions must occur during the sampling process.

In some mass spectrometers, RF and/or DC voltages can be applied to various components of the mass spectrometer, e.g., the rods of an ion guide or a mass filter implemented as a plurality of rods arranged in a multipole configuration (e.g., a quadrupole configuration) to generate electromagnetic fields for confining the ions and/or selecting ions having m/z ratios of interest. Typically, RF blocking filters or RF chokes are employed in such mass spectrometers for choking off or suppressing high-frequency alternating current signals (typically at RF frequencies) and allowing the passage of low-frequency and DC signals to the desired component(s). However, these filters generally exhibit a high power dissipation and can be bulky. Further, these filters can have low cut-off frequencies and high settling times, which can result in excessive rise and fall times of DC bias voltage elements. This can affect the ability to achieve fast DC voltage changes.

### SUMMARY

In accordance with at least one embodiment of the present disclosure there is provided a mass spectrometer, comprising a vacuum chamber, at least one ion optic element disposed in said vacuum chamber, a DC voltage source positioned external to said vacuum chamber and electrically coupled to said ion optic element for application of a DC voltage thereto, an RF voltage source positioned external to said vacuum chamber and electrically coupled to said ion optic for application of an RF voltage thereto, an RF choke positioned in said vacuum chamber and electrically connected between said DC voltage source and said RF voltage source, the RF choke comprising a bobbin having a hollow channel, a plurality of windings wrapped around the bobbin, each of said windings exhibiting a lattice winding pattern, a magnetic core disposed in said hollow channel of the bobbin, wherein said RF choke exhibits an impedance in a range of about 15 Mohm to about 150 Mohm for RF frequencies generated by said RF voltage source in a range of about 500 kHz to about 3 MHz, and a power dissipation equal to or less than about 3 W for a peak-to-peak RF voltage of said RF voltage source of at least about 1 kV.

In accordance with another embodiment of a mass spectrometer of the present disclosure, the peak-to-peak RF voltage is in a range of about 1 kV to about 10 kV.

Another embodiment of a mass spectrometer of the present disclosure further comprises a resin dispersed in said hollow channel of the bobbin to inhibit formation of air pockets between said magnetic core and said bobbin.

In accordance with another embodiment of a mass spectrometer of the present disclosure, the resin further covers at least a portion of an external surface of said plurality of windings.

In accordance with another embodiment of a mass spectrometer of the present disclosure, each of the windings has a lattice winding pattern exhibiting a crossover per turn in a range of about 1 to about 4.

In accordance with another embodiment of a mass spectrometer of the present disclosure, the crossover per turn is in a range of about 1.7 to about 2.5.

In accordance with another embodiment of a mass spectrometer of the present disclosure, the crossover per turn is selected based upon the frequency generated by said RF voltage source and the impedance of the RF choke.

In accordance with another embodiment of a mass spectrometer of the present disclosure, the magnetic core exhibits a power dissipation less than about 3 W for the RF frequencies in said range of about 500 kHz to about 3 MHz for said peak-to-peak RF voltage of at least about 1 kV.

In accordance with another embodiment of a mass spectrometer of the present disclosure, the magnetic core comprises any of a ferromagnetic and ferrimagnetic material.

In accordance with another embodiment of a mass spectrometer of the present disclosure, the magnetic core comprises ferrite.

In accordance with another embodiment of a mass spectrometer of the present disclosure, the RF choke has a maximum size less than about 3 cm in any of X, Y, and Z Cartesian coordinates.

In accordance with another embodiment of a mass spectrometer of the present disclosure, the RF choke has a length less than about 5 cm and a diameter less than about 3 cm.

In accordance with another embodiment of a mass spectrometer of the present disclosure, the mass ion optic element comprises a set of rods arranged in a multipole configuration.

In accordance with another embodiment of a mass spectrometer of the present disclosure, the multipole configuration is a quadrupole configuration.

In accordance with another embodiment of a mass spectrometer of the present disclosure, the ion optic element comprises an ion lens.

In accordance with another embodiment of a mass spectrometer of the present disclosure, the ion optic element comprises an ion mass filter.

In accordance with another embodiment of a mass spectrometer of the present disclosure, the ion optic element comprises an ion guide.

In accordance with another embodiment of a mass spectrometer of the present disclosure, the said vacuum chamber is maintained at a pressure in a range of about 1×10⁻⁸ Torr to about 50 milli-Torr.

In accordance with another embodiment of a mass spectrometer of the present disclosure, the mass spectrometer is configured for performing MRM (multiple reaction monitoring) mass analysis.

Another embodiment of a mass spectrometer of the present disclosure further comprises a plurality of ion optic elements, a plurality of RF chokes and a plurality of vacuum chambers, each ion optic element being connected to a corresponding RF choke in a respective vacuum chamber.

In accordance with at least one embodiment of the present disclosure there is provided a radio frequency (RF) choke for use in a mass spectrometer, comprising a bobbin having a hollow channel, a plurality of wire windings wrapped around said bobbin, each of said wire windings exhibiting a lattice winding pattern having about 1 to about 4 crossovers per turn, and a magnetic core disposed in said hollow channel of the bobbin, wherein said RF choke exhibits an impedance in a range of about 15 Mohm to about 150 Mohm for RF frequencies generated by an RF voltage source in a range of about 500 KHz to about 3 MHz, and a power dissipation equal to or less than about 3 W for a peak-to-peak RF voltage of said RF voltage source at least about 1 kV.

In accordance with another embodiment of a RF choke of the present disclosure, the peak-to-peak RF voltage is in a range of about 1 kV to about 10 kV.

Another embodiment of a RF choke of the present disclosure further comprises a resin dispersed in said hollow channel of the bobbin to inhibit formation of air pockets between said magnetic core and said bobbin.

In accordance with another embodiment of a RF choke of the present disclosure, the resin further covers at least a portion of an external surface of said plurality of windings.

In accordance with another embodiment of a RF choke of the present disclosure, each of the windings has a lattice winding pattern exhibiting a crossover per turn in a range of about 1 to about 4.

In accordance with another embodiment of a RF choke of the present disclosure, the crossover per turn is in a range of about 1.7 to about 2.5.

In accordance with another embodiment of a RF choke of the present disclosure, the crossover per turn is selected based upon the frequency generated by said RF voltage source and the impedance of the RF choke.

In accordance with another embodiment of a RF choke of the present disclosure, the magnetic core exhibits a power dissipation less than about 3 W for the RF frequencies in said range of about 500 kHz to about 3 MHz for said peak-to-peak RF voltage of at least about 1 kV.

In accordance with another embodiment of a RF choke of the present disclosure, the magnetic core comprises any of a ferromagnetic and ferrimagnetic material.

In accordance with another embodiment of a RF choke of the present disclosure, the magnetic core comprises ferrite.

In accordance with another embodiment of a RF choke of the present disclosure, the RF choke has a maximum size less than about 3 cm in any of X, Y, and Z Cartesian coordinates.

In accordance with another embodiment of a RF choke of the present disclosure, the RF choke has a length less than about 5 cm and a diameter less than about 3 cm.

### BRIEF DESCRIPTION OF THE DRAWINGS

FIG. 1 is a schematic view of a mass spectrometer according to an embodiment of the present teachings,

FIGS. 2A-2B depict the incorporation of RF chokes according to an embodiment of the present teachings in a mass spectrometer having multiple ion optic elements, and

FIGS. 3A-3F show various schematic diagrams of an RF choke according to an embodiment of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed in any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a value of about 10 or substantially equal to 10 can mean a concentration between 9 and 11. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

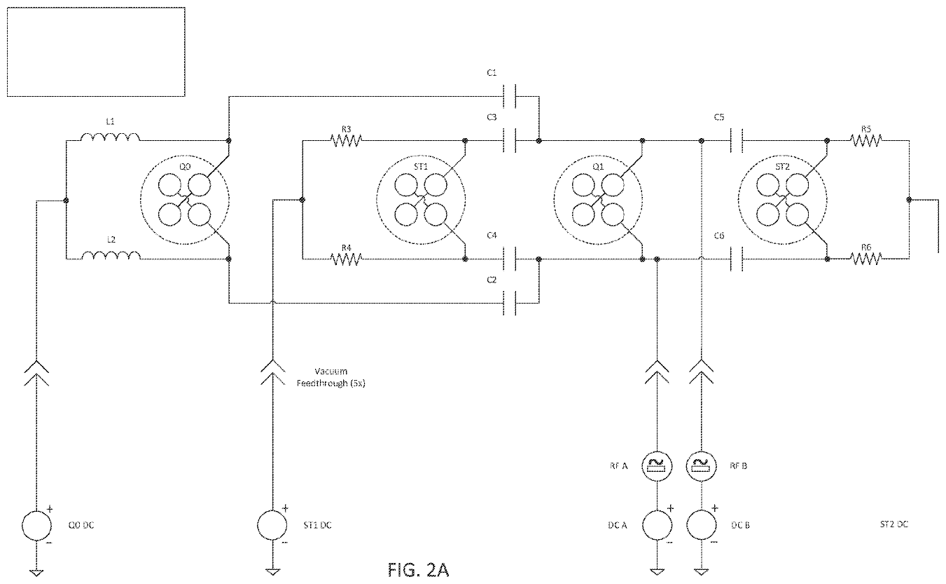

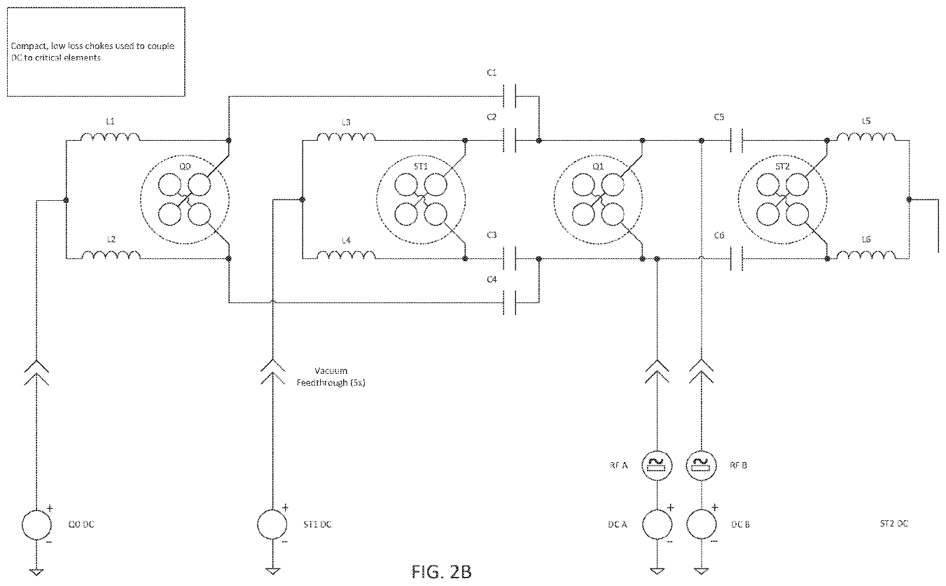

The term “crossover per turn” is known in the art as applied to a wire winding and refers to the number of times the wire crosses from one side of winding section to the opposed side of the winding section in one full rotation of the bobbin. FIG. 2 of “Universal Coil Winding” from the Radio and Electrical Review (March 1961; pages 13-20, 38), which is hereby incorporated by reference in its entirety, illustrates an example winding pattern having two (2) crossovers per turn.

The term “vacuum,” as used herein, refers to a pressure regime less than about 10 Torr, e.g., in a range of about 10 Torr to about 10⁻⁸ Torr.

The term “ion optic element,” as used herein refers to any component of a mass spectrometer to which RF and DC voltages are applied and which influences the trajectory of ions by creating an electromagnetic field.

Typically, RF blocking filters or RF chokes are designed as fixed inductors and are employed in mass spectrometers with the purpose of choking off or suppressing high-frequency alternating current (AC) signals and allowing the passage of low-frequency and DC signals to one or more components of the mass spectrometer, such as its ion guides. For example, an RF choke inductor can be used in a mass spectrometer to facilitate the application of DC voltages to ion optics elements that are also connected to a high frequency RF voltage source. The RF choke inductor can be coupled to the electrical connections of mass spectrometer elements contained in a vacuum such as a quadrupole assembly.

The present disclosure relates to RF blocking filters, RF chokes and resonant inductive filters for use in a mass spectrometer. The RF choke of the present disclosure can be designed as a fixed inductor that can choke off or suppress high-frequency alternating current (AC) signals and allow the passage of low-frequency and DC signals. The RF choke can be constructed so that it exhibits high impedance at RF frequencies associated with RF signals applied to components of the mass spectrometer, e.g., RF signals that may be applied to rods of a multipole (e.g., quadrupole) ion guide, particularly at high RF voltages. An RF choke according to the present teachings can also exhibit fast settling times when fast switching of high DC voltage(s) applied to a component of the mass spectrometer, e.g., a mass filter, is needed. Increasing the speed of the DC switching can enable fast ion transfer and trapping of ions between different regions of ion paths within a mass spectrometer. For example, such a fast switching of high DC voltage(s) can be employed in multiple reaction monitoring (MRM) and in some embodiments, the use of an RF choke according to the present teachings can allow increasing the switching speed of voltage(s) when employed in MRM mass analysis of a sample, thereby improving MRM throughput.

An RF choke according to the present teachings can also exhibit a sufficiently low power dissipation even when high RF voltages are applied thereto such that it is feasible to employ it in a vacuum chamber of a mass spectrometer in absence of cooling via convection. The RF choke also can be constructed so that it exhibits low impedance in the DC domain, which facilitates fast changes at the DC level applied to the ion optic elements.

Due to its low power dissipation, the RF choke inductor of the present disclosure can be used with electrical connections of mass spectrometer elements (e.g., ion optic elements) contained in a vacuum chamber, such as rods of a multipole assembly (e.g., a quadrupole assembly) and ion lenses placed in a vacuum. In such vacuum environments, cooling via convection is not possible and hence the power dissipation of an element placed in a vacuum environment becomes a limiting factor that can determine whether that element can be employed in that environment. As noted above, an RF choke inductor of the present disclosure can exhibit a low power dissipation and hence can be used in a vacuum environment. For example, the power dissipation of an RF choke according to the present teachings for frequencies in a range of about 500 kHz to about 3 MHz and peak-to-peak voltage amplitudes in a range of about 1 kV to about 10 kV can be equal to or less than about 5 Watts (W), e.g., in a range of about 0 W to about 5 W, such as in the range of about 1 W to about 3 W.

Further, the RF choke can have a small footprint that allows for concurrent incorporation of a plurality of RF chokes in multiple sections of an ion path within a mass spectrometer. In fact, in some embodiments, the combination of the small size of the RF choke and its low power dissipation at RF frequencies of interest makes it possible to have an RF choke connected to every ion optic element of interest, including those that can experience a fast change in a DC voltage applied thereto.

Various aspects of the present teachings are described in connection with a quadrupole/time-of-flight mass spectrometer. It should, however, be understood that the present teachings can be used with other types of mass spectrometric systems, e.g., triple quadrupole mass spectrometers, linear ion-trap mass spectrometers, or 3-D ion-trap mass spectrometers.

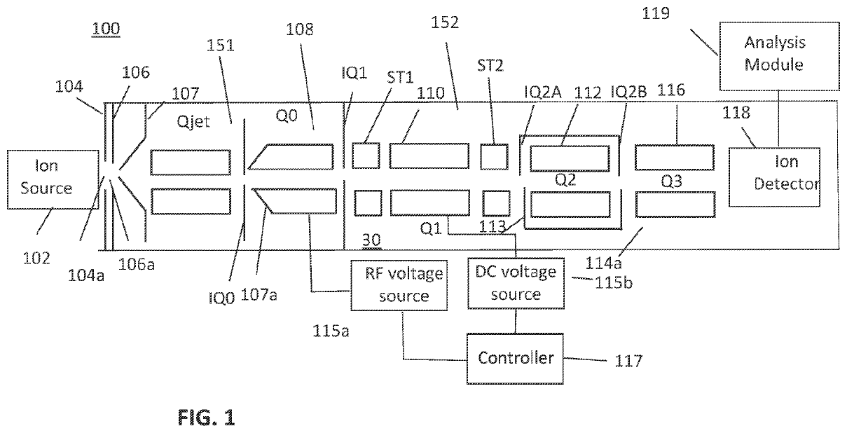

FIG. 1 schematically depicts an example mass spectrometer 100 in which one or more RF chokes according to the present teachings can be incorporated. The mass spectrometer 100 includes an ion source 102 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 104a of a curtain plate 104 and an orifice 106a of an orifice plate 106, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 104 and the orifice plate 106 to help keep the downstream sections of the mass spectrometer clean by declustering and repelling large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions pass through an orifice 106a of an orifice plate 106 to be received by an ion optic QJet, which includes four rods (two of which are shown in the figure) arranged in a quadrupole configuration to which RF voltages can be applied to generate a quadrupolar electric field in the space between the rods. The Qjet optic can capture and focus the ions using a combination of gas dynamics and radio frequency fields.

The ions are then transmitted via an ion lens IQ0 into an ion guide Q0, which comprises four rods 108 (two of which are visible in this figure) that are arranged in a quadrupole configuration to form an ion beam for transmission to downstream components of the mass spectrometer.

The ion beam exits the Q20 ion guide and is focused via an ion lens IQ1 and a quadrupole prefilter lens ST1 into a subsequent ion mass filter Q1, which includes four rods 110 (two of which are visible in this figure) that are arranged in a quadrupole configuration and to which RF voltages as well as a DC resolving voltage can be applied for radially focusing the ions and selecting ions having a target m/z. ratio (herein referred to as precursor ions) as they pass through the Q1 mass analyzer. In other embodiments, other multipole configurations, such as a hexapole or an octupole configuration, can be utilized.

More specifically, in this embodiment, the quadrupole rod set Q1 can be operated as a conventional transmission RF/DC quadrupole mass filter for selecting ions having an m/z. value of interest or m/z values within a range of interest. By way of example, the quadrupole rod set Q1 can be provided with RF/DC voltages suitable for operation in a mass-resolving mode. For example, parameters of the applied RF and DC voltages can be selected so that Q1 establishes a transmission window of chosen m/z ratios, such that these ions can traverse Q1 largely unperturbed. Ions having m/z. ratios falling outside the window, however, do not attain stable ion trajectories within the quadrupole and can be prevented from traversing the quadrupole rod set Q1. It should be appreciated that this mode of operation is but one possible mode of operation for Q1. In this embodiment, the Q20 ion guide and the Q1 mass filter are disposed in differentially pumped vacuum chambers 151 and 152, respectively. By way of example, the vacuum chamber 151 can be maintained at a pressure in a range of about 3 to about 12 mTorr, and the vacuum chamber 152 can be maintained at a pressure in a range of about 1 to about 50 μTorr.

The ions passing through the Q1 mass analyzer are focused via a quadrupole pre-filter lens ST2 and an ion lens IQ2A into a collision cell Q2. The collision cell Q2 includes four rods 112 (two of which are visible in this figure) that are arranged in a quadrupole configuration and to which RF voltages can be applied for providing radial confinement of the ions. The rods 112 are disposed within an enclosure 113 such that the pressure within the collision cell can be increased relative to the other stages, e.g., via introduction of a gas (e.g., nitrogen) into the enclosure. While in some embodiments the collision cell Q2 is employed to cause fragmentation of the ions received by the collision cell, in other embodiments, the collision cell Q2 is not utilized for ion fragmentation, but rather for causing, for example, collisional cooling of the ions.

The fragment ions exiting the collision cell are received by a downstream Q3 quadrupole mass analyzer 116 and are separated based on their m/z ratios to be detected via an ion detector 118. The Q3 quadrupole mass analyzer includes four rods that are arranged in a quadrupole configuration and to which RF and DC voltages can be applied.

An analysis module 119 is in communication with the ion detector 118 to receive ion detection signals (e.g., electrical pulses) generated by the ion detector 118 and to process those signals to generate a mass spectrum of the detected ions.

An RF voltage source 115a and a DC voltage source 115b operating under the control of a controller 117 can apply the requisite RF and DC voltages to various components of the mass spectrometer 100. By way of example, the RF voltage source 115a can apply RF voltages to the quadrupole rods of Q0 ion guide. The Q1 mass filter, Q2 collision cell, and Q3 mass analyzer are capacitively coupled to the rods of the Q0 ion guide to receive RF voltages via such capacitive coupling. The RF voltages applied to the rods of the Q0 ion guide, the Q1 mass filter and the Q2 collision cell provide an electromagnetic field for causing radial confinement of the ions and/or selecting ions with desired m/z. ratios to pass through the quadrupole rods. The DC voltage source 115b can apply a DC discriminating voltage to the quadrupole rods of the Q1 mass filter for selecting ions having m/z. ratios of interest.

An RF choke according to the present teachings can be used in a mass spectrometer, such as the mass spectrometer 100 of FIG. 1, or in any mass spectrometer that includes an ion optic element positioned in a vacuum chamber to which RF and DC voltages should be applied. The ion optic element can be any component that is powered by a DC voltage source and/or an RF voltage source, such as an ion lens, an ion mass filter, an ion guide or rods arranged in a multipole configuration.

By way of illustration, FIGS. 2A and 2B depict the incorporation of an RF choke according to an embodiment of the present teachings in a mass spectrometer having multiple ion optic elements that receive RF voltages via capacitive coupling to the quadrupole rods of a main quadrupole Q0 ion guide, which are directly coupled to an RF voltage source to receive RF voltages thereof (that is, these ion optic elements slave their RF off a main quadrupole Q0. More specifically, as shown in FIGS. 2A and 2B, the mass spectrometer can include a main quadrupole ion guide Q0, a quadrupole prefilter ST1, a quadrupole mass filter Q1, and another quadrupole prefilter ST2. The quadrupole Q1, which is electrically coupled to an RF source RFA and a DC source DCA, can be capacitively coupled to quadrupole prefilters ST1 and ST2 and to main quadrupole Q0.

As shown in FIG. 2A, in conventional mass spectrometry systems, very large chokes (schematically shown as inductors L1 and L2) are coupled to main quadrupole Q0 in order to reduce settling times when applied voltages (e.g., DC voltages) are switched. Due to their large size, these chokes could not be coupled with quadrupole prefilters ST1 and ST2. Rather resistors (R3-R6) having large settling times are typically used. As described in detail below, in many embodiments, an RF choke according to the present disclosure can have a compact size and therefore can be used in place of the resistors R3-R6, as shown in FIG. 2B, so that all of the critical optical elements can exhibit faster settling times, which can be advantageous, for example, in fast MRM analysis of analytes. Also, replacing resistors with RF chokes can allow for higher RF coupling as there is lower power dissipation. This in turn in combination with the fast rise and fall time of the DC voltage can eliminate ion trapping. Also, replacing resistors with RF chokes can eliminate crosstalk across RF coupled optical elements.

The use of RF choke(s) according to the present teachings in a mass spectrometer is not limited to circuitry employed for application of RF and DC voltages to the quadrupole rods of a mass filter or an ion guide. Rather, an RF choke according to the present teachings can be used in a mass spectrometer as part of circuitry used for application of DC and RF voltages to any ion optic element.

In some embodiments, one or more RF chokes according to the present teachings can be employed in the Q0 region of the mass spectrometer.

Preferably, an RF choke according to the present teachings, such as the RF chokes 200 described below, is disposed in a vacuum chamber in which the ion optic element(s) of interest (e.g., ion guide rods, such as prefilter quadrupole rods are positioned. In general, an RF choke according to the present teachings can be used in any location, including in a vacuum environment in which convectional cooling of the RF choke is not feasible. In one embodiment, a respective RF choke can be positioned in each of a plurality of vacuum chambers each of which contains at least one ion optic element to which RF and/or DC voltages are applied, where each ion optic element is connected to a corresponding RF choke in a respective vacuum chamber.

As presented below, an RF choke according to embodiments of the present teachings can be constructed such that it exhibits a high impedance at the frequency of the applied RF signal. This can reduce the power dissipation, which renders the use of the RF choke in a vacuum environment practical. The RF choke also can be constructed so that it exhibits low impedance in the DC domain, which facilitates fast changes of DC voltages applied to the ion optic elements. Also, the choke can be constructed so that it has a small footprint that allows the concurrent use of a plurality of RF chokes in multiple sections of the ion path in a mass spectrometer.

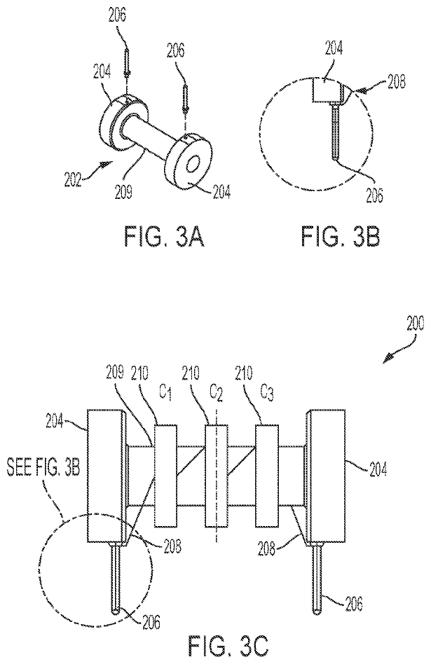

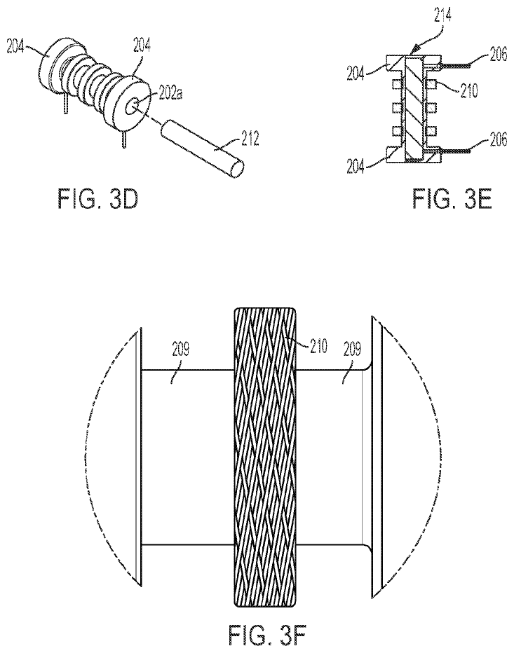

As shown in FIGS. 3A-3E, at least one embodiment of an RF choke 200 according to the present teachings comprises a bobbin 202, onto which wires can be wound as described below so as to provide three wire winding sections, though other numbers of wire winding sections can also be used. The bobbin 202 can be formed of a material exhibiting a low dielectric loss at RF frequencies in a range of about 500 kHz to about 3 MHz, such as low dissipation factor plastic or glass or mineral filled plastic materials—such as polyetherimide (e.g., ULTEM, Polyethylene, Polypropylene), resins (Polyphthalamide) or machinable ceramics (e.g., Macore, Aluminum nitride, etc.)]. The bobbin 202 comprises two flanges 204 into which pins 206 are inserted, as shown in FIG. 3A. The pins 206 can be press fit into the flanges 204. As shown in FIG. 3B, a wire 208 can be wrapped around the base of the pins 206 and then soldered to the pins 206. The wire 208 can then be wound onto the bobbin to form a plurality of circular sections 210 on a central portion 209 of the bobbin 202, as shown in FIG. 3C. The number of wire circular sections can be in a range of approximately 2-6.

By way of example, the wire 208 can be wound approximately 400 turns at each of the plurality of circular sections 210, though other numbers of turns can also be employed, e.g., in a range of about 300 to about 1500 turns. In at least one embodiment, the wire 208 can be wound around the bobbin such that the windings exhibit a crisscross pattern of wire layers such that each wire in a layer crosses a respective wire at a lower layer at an angle, as shown in FIG. 3F. Such a crisscross pattern is known in the art as “universal winding,” “honeycomb winding,” or “lattice winding.”

More specifically, each section can be constructed using a number of crossover per turn of between approximately 1 and 4, and preferably in the range of 1.7 to 2.5. The crossover per turn can be selected, at least partly, based upon the RF frequency (or RF frequency range) for which the RF choke is designed and the desired impedance of the RF choke at those frequencies. For example, for RF frequencies in a range of about 500 kHz to about 3 MHz and a respective impedance in a range of about 15 Mohm to about 150 Mohm, the crossover per turn of the wire windings of an RF choke according to the present teachings can be in a range of about 1 to about 4, e.g., in a range of about 1.7 to about 2.5, or in a range of about 1.8 to about 2.2.

As shown in FIG. 3D, in this embodiment, the bobbin 202 includes a central cavity 202a that extends along the length of the bobbin 202 between its flanges 204 and a magnetic core 212 is inserted into the central cavity. A ferrimagnetic or a ferromagnetic material could be used for the magnetic core 212. The magnetic core 212 can be made from a material such that a desired low loss of the choke at the frequency of the applied RF signal can be achieved. Some examples of suitable ferrimagnetic or ferromagnetic materials include, without limitation, ferrite (e.g., 4B1 NiZn), powdered molypermalloy, sendust, iron powder, or powdered silicon-iron alloy. An epoxy seal 214 can be added to the end of the bobbin 202, as shown in FIG. 3E, in order to seal the magnetic core 212 within cavity 202a of the bobbin 202.

By way of example, in at least one embodiment, the length of the bobbin 202 can be in a range of about 3 cm to about 5 cm. The flanges 204 of the bobbin 202 can have a diameter in a range of about 2 cm to about 3 cm. Further, the inner diameter of the cavity 202a can be about 6 mm, and the wall thickness the cavity 202a be about 2 mm. The circular wire sections 210 of the bobbin 202 can have a diameter in a range of about 12 mm to about 20 mm and a thickness in a range of about 3 mm to about 3.5 mm. In at least one embodiment, the maximum size of the bobbin 202 in any of the three dimensions (e.g., X, Y and Z cartesian dimensions) can be equal to or less than about 3 cm, e.g., in a range of about 1 cm to about 2 cm.

A low outgassing type resin (herein also referred to as a varnish) can be introduced into the central cavity so that it fills the gaps, if any, between the magnetic core 212 and the bobbin 202 so as to inhibit, and preferably prevent, the occurrence of arcing (corona discharge) when high RF voltages are applied to the wire windings. Such a varnish, or a different varnish, can also be applied to the outer surfaces of the wire windings.

In at least one embodiment, the inductance of the RF choke (e.g., an inductance measured between the pins 206) can be approximately 42.5 mH, or in a range of about 40-45 mH for RF frequencies in a range of about 500 kHz to about 3 MHz. Further, in some such embodiments, the DC resistance of the RF choke (e.g., as measured between the pins 206) can be approximately 108 Ω, or in a range of about 100-115 Ω. The above-described configuration for the RF choke can result in an equivalent impedance of approximately 15 Mohm-150 Mohm in a frequency range between approximately 500 KHz to 3 MHz, which can allow the operation of the RF choke at a power level that is low enough to allow positioning of the RF choke to operate in a vacuum environment, and particularly within an evacuated chamber of a mass spectrometer. For example, in some embodiments, the power dissipation exhibited by an RF choke according to the present teachings for an applied peak-to-peak RF voltage of at least about 1 kV can be less than about 3 W.

In at least one embodiment, the RF choke can comprise a resin layer coating on at least a portion of an external surface of at least one of the wire windings.

Those having ordinary skill in the art will appreciate that various changes can be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A mass spectrometer, comprising:
a vacuum chamber,
at least one ion optic element disposed in said vacuum chamber,
a DC voltage source positioned external to said vacuum chamber and electrically coupled to said ion optic element for application of a DC voltage thereto,
an RF voltage source positioned external to said vacuum chamber and electrically coupled to said ion optic for application of an RF voltage thereto, and
an RF choke positioned in said vacuum chamber and electrically connected between said DC voltage source and said RF voltage source,
said RF choke comprising:
a bobbin having a hollow channel,
a plurality of windings wrapped around the bobbin, each of said windings exhibiting a lattice winding pattern,
a magnetic core disposed in said hollow channel of the bobbin,
wherein said RF choke exhibits an impedance in a range of about 15 Mohm to about 150 Mohm for RF frequencies generated by said RF voltage source in a range of about 500 KHz to about 3 MHz, and a power dissipation equal to or less than about 3 W for a peak-to-peak RF voltage of said RF voltage source of at least about 1 kV.

2. The mass spectrometer of claim 1, wherein said peak-to-peak RF voltage is in a range of about 1 kV to about 10 kV.

3. The mass spectrometer of claim 1, further comprising a resin dispersed in said hollow channel of the bobbin to inhibit formation of air pockets between said magnetic core and said bobbin.

4. The mass spectrometer of claim 3, wherein said resin further covers at least a portion of an external surface of said plurality of windings.

5. The mass spectrometer of claim 1, wherein each of said windings has a lattice winding pattern exhibiting a crossover per turn in a range of about 1 to about 4.

6. The mass spectrometer of claim 5, wherein said crossover per turn is in a range of about 1.7 to about 2.5.

7. The mass spectrometer of claim 5, wherein the crossover per turn is selected based upon the frequency generated by said RF voltage source and the impedance of the RF choke.

8. The mass spectrometer of claim 4, wherein said magnetic core exhibits a power dissipation less than about 3 W for the RF frequencies in said range of about 500 kHz to about 3 MHz for said peak-to-peak RF voltage of at least about 1 kV.

9. The mass spectrometer of claim 8, wherein said magnetic core comprises any of a ferromagnetic and ferrimagnetic material, and wherein said ferrimagnetic material optionally comprises ferrite.

10. (canceled)

11. The mass spectrometer of claim 1, wherein said RF choke has a maximum size less than about 3 cm in any of X, Y, and Z Cartesian coordinates.

12. The mass spectrometer of claim 11, wherein said RF choke has a length less than about 5 cm and a diameter less than about 3 cm.

13. The mass spectrometer of claim 1, wherein said mass ion optic element comprises a set of rods arranged in a multipole configuration.

14. The mass spectrometer of claim 13, wherein said multipole configuration is a quadrupole configuration.

15. The mass spectrometer of claim 1, wherein said ion optic element comprises an ion lens.

16. The mass spectrometer of claim 1, wherein said ion optic element comprises an ion mass filter.

17. The mass spectrometer of claim 1, wherein said ion optic element comprises an ion guide.

18. The mass spectrometer of claim 1, wherein said vacuum chamber is maintained at a pressure in a range of about 1×10⁻⁸ Torr to about 50 milli-Torr.

19. The mass spectrometer of claim 1, wherein said mass spectrometer is configured for performing MRM (multiple reaction monitoring) mass analysis.

20. The mass spectrometer of claim 1, further comprising a plurality of ion optic elements, a plurality of RF chokes and a plurality of vacuum chambers, each ion optic element being connected to a corresponding RF choke in a respective vacuum chamber.

21. A radio frequency (RF) choke for use in a mass spectrometer, comprising:
a bobbin having a hollow channel,
a plurality of wire windings wrapped around said bobbin, each of said wire windings exhibiting a lattice winding pattern having about 1 to about 4 crossovers per turn, and
a magnetic core disposed in said hollow channel of the bobbin, wherein said RF choke exhibits an impedance in a range of about 15 Mohm to about 150 Mohm for RF frequencies generated by an RF voltage source in a range of about 500 KHz to about 3 MHz, and a power dissipation equal to or less than about 3 W for a peak-to-peak RF voltage of said RF voltage source at least about 1 kV.

22-32. (canceled)
